(19) United States
(12) Patent Application Publication
(10) Pub. No.: US 2015/0361977 A1
(43) Pub. Date: Dec. 17, 2015

(54) OIL PUMP FOR AUTOMATIC TRANSMISSION

(71) Applicants: Hyundai Motor Company, Seoul (KR); Magna Powertrain Korea Inc., Cheonan-si (KR)

(72) Inventors: Wonmin Cho, Hwaseong-si (KR); Jongsu Lee, Anseong-si (KR)

(73) Assignees: Hyundai Motor Company, Seoul (KR); Magna Powertrain Korea Inc., Cheonan-si (KR)

(21) Appl. No.: 14/543,059

(22) Filed: Nov. 17, 2014

(30) Foreign Application Priority Data
Jun. 11, 2014 (KR) 10-2014-0070767

(51) Int. Cl. F04C 11/00; F16H 57/04; F04C 2/344; F04C 15/00; F04C 2/10; F16H 61/00; F04C 13/00

(52) U.S. Cl. CPC F04C 11/001; F16H 61/0025; F16H 57/0441; F04C 13/002; F04C 15/0061; F04C 15/008; F04C 2/10; F04C 2/344; F16H 2061/0037; F16H 2061/0046

(57) ABSTRACT

An oil pump apparatus may include a housing provided with at least one hydraulic line formed therein, a power source assembled to the housing and configured to apply torque through a drive shaft, and two pumps disposed respectively at both end portions of the housing concentrically with the drive shaft, operably connected to each other through a torque delivery shaft, and pumping oil by receiving the torque from the drive shaft, wherein an inner rotor of one pump may be operably connected to the drive shaft, integrally formed with a boss portion, and operably connected to the torque delivery shaft operably connected to an inner rotor of the other pump through the boss portion.

### CROSS-REFERENCE TO RELATED APPLICATION

The present application claims priority to and the benefit of Korean Patent Application No. 10-2014-0070767 filed on Jun. 11, 2014, the entire contents of which is incorporated herein for all purposes by this reference.

### BACKGROUND OF THE INVENTION

1. Field of the Invention

The present invention relates to an oil pump for an automatic transmission. More particularly, the present invention relates to an oil pump for an automatic transmission in which two pumps driven by one electric motor is mounted in one housing.

2. Description of Related Art

Recently, vehicle makers direct all their strength to improve fuel economy due to worldwide high oil prices and strengthen of exhaust gas regulations.

Improvement of fuel economy may be achieved by minimizing unnecessary power consumption of an oil pump.

A recent automatic transmission is provided with a low-pressure oil pump and a high-pressure oil pump so as to improve fuel economy. Therefore, hydraulic pressure generated by the low-pressure oil pump is supplied to a low pressure portion (i.e., a torque converter, a cooling device, and a lubrication device), and hydraulic pressure generated by the high-pressure oil pump is supplied to a high pressure portion (i.e., friction members selectively operated when shifting).

In further detail, general hydraulic pressure of the automatic transmission is generated for the low pressure portion (i.e., generated by the low-pressure oil pump), and hydraulic pressure demanded by the high pressure portion is generated by the high-pressure oil pump and then is supplied to the high pressure portion.

FIG. 1 is a schematic diagram of an exemplary hydraulic pressure supply system of an automatic transmission.

Referring to FIG. 1, a hydraulic pressure supply system is adapted to supply a low hydraulic pressure generated by a low-pressure oil pump 2 to a low pressure portion 4 such as a torque converter (T/C), a cooling portion, and a lubrication portion, and to supply high hydraulic pressure generated by a high-pressure oil pump 6 to a high pressure portion 8 for operating friction members related to shifting.

That is, the hydraulic pressure generated by the low-pressure oil pump 2 is regulated to be stable hydraulic pressure by low-pressure regulator valve 10 and is then supplied to the low pressure portion 4. The high-pressure oil pump 6 increases the low hydraulic pressure supplied from the low-pressure oil pump 2 to the high hydraulic pressure, and the increased hydraulic pressure by the high-pressure oil pump 6 is regulated to be stable hydraulic pressure by a high-pressure regulator valve 12 and is then supplied to the high pressure portion 8.

In order to optimize operation of a hydraulic pressure supply system of an automatic transmission, an oil pump for an automatic transmission where the low-pressure oil pump 2 and the high-pressure oil pump 6 are simultaneously driven by one power source is used.

That is, researches for minimizing a length of an oil pump for an automatic transmission and reducing weight and cost has been vividly developed by optimizing power delivery between the low-pressure oil pump 2 and the high-pressure oil pump 6.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an oil pump for an automatic transmission having advantages of minimizing length, weight, and cost thereof due to reduction of the number components by mounting two pumps driven by one electric motor in one housing.

An oil pump for an automatic transmission according to an exemplary embodiment of the present invention may include: a housing provided with at least one hydraulic line formed therein; a power source assembled to the housing and adapted to apply torque through a drive shaft; and two pumps disposed respectively at both end portions of the housing concentrically with the drive shaft, operably connected to each other through a torque delivery shaft, and pumping oil by receiving the torque from the drive shaft, wherein an inner rotor of one pump is operably connected to the drive shaft, integrally formed with a boss portion, and operably connected to the torque delivery shaft operably connected to an inner rotor of another pump through the boss portion.

The two pumps may include: a low-pressure oil pump being another oil pump, receiving the oil in an oil tank through the at least one hydraulic line, generating low pressure using the oil, and discharging the generated low pressure; and a high-pressure oil pump being the one oil pump, receiving a portion of the low pressure discharged from the low-pressure oil pump, generating high pressure using the portion of the low pressure, and discharging the generated high pressure.

The at least one hydraulic line may include: an input line adapted to supply the oil in the oil tank to the low-pressure oil pump; a low-pressure discharge line adapted to supply the oil discharged from the low-pressure oil pump to a low pressure portion; a bifurcating line bifurcated from the low-pressure discharge line so as to supply a portion of the oil in the low-pressure discharge line to the high-pressure oil pump; and a high-pressure discharge line adapted to supply the oil discharged from the high-pressure oil pump to a high pressure portion.

The power source may be an electric motor.

Each of the two pumps may be a vane pump.

Each of the two pumps may be a gear pump.

The boss portion may have a cylindrical shape, may be integrally formed with an inner portion of the inner rotor of the one oil pump, and may operably connect the drive shaft with the torque delivery shaft together with the inner rotor of the one oil pump.

The drive shaft and the torque delivery shaft may be splined or may be coupled through a key or a polygonal shape respectively to the inner rotor of the one oil pump and the boss portion for power delivery.

An exterior circumference of the boss portion may be rotatably supported by a connecting hole formed in the housing.

An oil pump for an automatic transmission according to another exemplary embodiment of the present invention may include: a housing provided with at least one hydraulic line formed therein; an electric motor assembled to the housing and adapted to apply torque through a drive shaft; a low-pressure oil pump disposed at an end portion in the housing concentrically with the drive shaft, and generating and discharging low pressure by receiving oil in an oil tank through the at least one hydraulic line; a high-pressure oil pump disposed at another end portion in the housing concentrically with the drive shaft, including an inner rotor connected to the drive shaft, and generating and discharging high pressure by receiving a portion of oil discharged from the low-pressure oil pump; a torque delivery shaft in a connecting hole formed in the housing and provided with both end portions operably connected respectively to inner rotors of the low-pressure oil pump and the high-pressure oil pump; and a boss portion into which another end portion of the torque delivery shaft is operably inserted and integrally formed with an inner portion of the inner rotor of the high-pressure oil pump.

The at least one hydraulic line may include: an input line adapted to supply the oil in the oil tank to the low-pressure oil pump; a low-pressure discharge line adapted to supply the oil discharged from the low-pressure oil pump to a low pressure portion; a bifurcating line bifurcated from the low-pressure discharge line so as to supply a portion of the oil in the low-pressure discharge line to the high-pressure oil pump; and a high-pressure discharge line adapted to supply the oil discharged from the high-pressure oil pump to a high pressure portion.

Each of the low-pressure oil pump and the high-pressure oil pump may be a vane pump.

Each of the low-pressure oil pump and the high-pressure oil pump may be a gear pump.

The boss portion may have a cylindrical shape, may be integrally formed with an inner portion of the inner rotor of the high-pressure oil pump, and may operably connect the drive shaft with the torque delivery shaft together with the inner rotor of the high-pressure oil pump.

The drive shaft and the torque delivery shaft may be splined or may be coupled through a key or a polygonal shape respectively to the inner rotor of the high-pressure oil pump and the boss portion for power delivery.

An exterior circumference of the boss portion may be rotatably supported by the connecting hole.

An exterior circumference of an end portion of the torque delivery shaft may be rotatably supported by the connecting hole through a bearing.

An exterior circumference of an end portion of the torque delivery shaft may be rotatably supported by the connecting hole through a bushing.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary hydraulic pressure supply system of an automatic transmission.

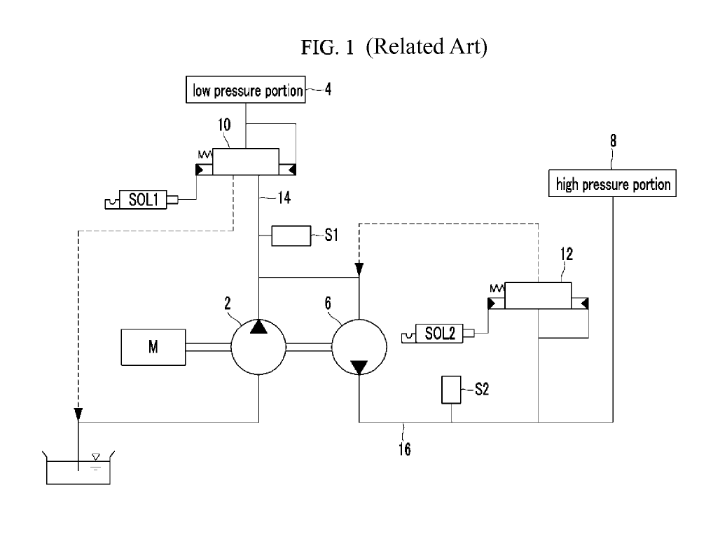

FIG. 2 is a cross-sectional view of an oil pump for an automatic transmission according to an exemplary embodiment of the present invention.

FIG. 3 is a perspective view illustrating some components used in an oil pump for an automatic transmission according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

Description of components that are not necessary for explaining the present exemplary embodiment will be omitted.

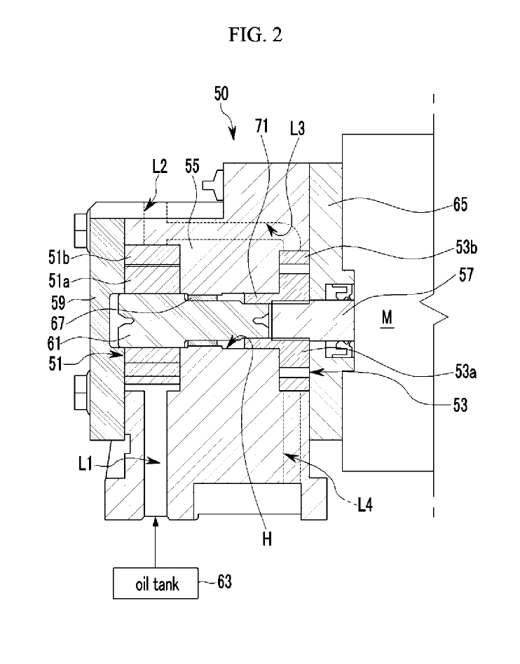

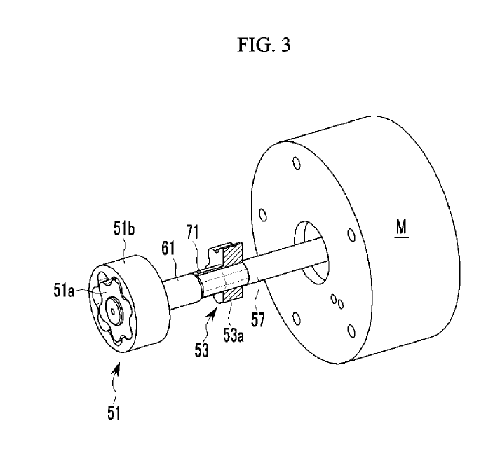

FIG. 2 is a cross-sectional view of an oil pump for an automatic transmission according to an exemplary embodiment of the present invention, and FIG. 3 is a perspective view illustrating some components used in an oil pump for an automatic transmission according to an exemplary embodiment of the present invention.

Referring to FIG. 2, an oil pump 50 for an automatic transmission according to an exemplary embodiment of the present invention includes a low-pressure oil pump 51 and a high-pressure oil pump 53 mounted in one housing 55. Low hydraulic pressure generated by the low-pressure oil pump 51 is supplied to a low pressure portion such as a torque converter (T/C), a cooling portion, and a lubrication portion, and high hydraulic pressure generated by the high-pressure oil pump 53 is supplied to a high pressure portion for operation friction members related to shifting.

The low hydraulic pressure is a lower pressure facilitating operation of the torque converter (T/C) and cooling and lubrication, and the high hydraulic pressure is a high pressure facilitating operation of a plurality of friction members.

Referring to FIG. 2, the low-pressure oil pump 51 and the high-pressure oil pump 53 are operably connected through one torque delivery shaft 61 and are driven by an electric motor M that is a power source in the oil pump 50 for an automatic transmission according to the exemplary embodiment of the present invention. The electric motor M may be controlled by a transmission control unit.

Hereinafter, the oil pump 50 for an automatic transmission according to the exemplary embodiment of the present invention will be described in further detail.

Referring to FIG. 2, the oil pump 50 for an automatic transmission according to the exemplary embodiment of the present invention includes the housing 55, the electric motor M, the low-pressure oil pump 51, the high-pressure oil pump 53, the torque delivery shaft 61, and a boss portion 71.

The housing 55 is formed by a single body, and is provided with at least one hydraulic line formed therein and a connecting hole H formed horizontally at a center portion in the housing.

The electric motor M is the power source and is assembled to the housing 55. The electric motor M provides torque through a drive shaft 57.

It is illustrated in the exemplary embodiment of the present invention that the power source is the drive motor M, but the power source is not limited to the drive motor M. The power source may be a hub receiving torque in a torque converter of an automatic transmission.

The low-pressure oil pump 51 is disposed in an end portion of the housing 55 concentrically with the drive shaft 57 and is enclosed by the housing 55 and a front cover 59 assembled to the housing 55. The low-pressure oil pump 51 receives oil in an oil tank 63 through an input line L1, generates hydraulic pressure for operating the torque converter (T/C), cooling and lubrication, and discharges the generated hydraulic pressure through a low-pressure discharge line L2.

The high-pressure oil pump 53 is disposed in the other end portion of the housing 55 concentrically with the drive shaft 57 and is enclosed by the housing 55 and a rear cover 65 assembled to the housing 55. An inner rotor 53a of the high-pressure oil pump 53 is connected to the drive shaft 57. The high-pressure oil pump 53 receives the oil discharged from the low-pressure oil pump 51 through a bifurcating line L3, generates relatively high hydraulic pressure for operating a plurality of friction members related to shifting, and discharges the high hydraulic pressure through a high-pressure discharge line L4.

The at least one hydraulic line includes the input line L1, the low-pressure discharge line L2, the bifurcating line L3, and the high-pressure discharge line L4.

The input line L1 is formed in the housing 55 and is adapted to supply the oil in the oil tank 63 to the low-pressure oil pump 51.

The low-pressure discharge line L2 is formed in the housing 55 and is adapted to supply the oil discharged from the low-pressure oil pump 51 to the low pressure portion of the automatic transmission.

In addition, the bifurcating line L3 is formed in the housing 55 and is adapted to supply a portion of the oil in the low-pressure discharge line L2 to the high-pressure oil pump 53. The bifurcating line L3 is bifurcated from the low-pressure discharge line L2 and is connected to the high-pressure oil pump 53.

The high-pressure discharge line L4 is formed in the housing 55 and is adapted to supply the oil discharged from the high-pressure oil pump 53 to the high pressure portion of the automatic transmission.

It is exemplified in exemplary embodiment of the present invention but is not limited that each of the low-pressure oil pump 51 and the high-pressure oil pump 53 is a gear pump. Each of the low-pressure oil pump 51 and the high-pressure oil pump 53 may be a vane pump. In this case, a plurality of vanes may be mounted at the inner rotors 51a and 53a of the low-pressure oil pump 51 and the high-pressure oil pump 53.

Referring to FIG. 3, the torque delivery shaft 61 is mounted in the connecting hole H formed in the housing 55, and is provide with an end portion connected to the inner rotor 51a of the low-pressure oil pump 51 and the other end portion connected to the inner rotor 53a of the high-pressure oil pump 53. Accordingly, the torque delivery shaft 61 delivers the torque of the electric motor M to the low-pressure oil pump 51 and the high-pressure oil pump 53.

The boss portion 71 is operably mounted on the torque delivery shaft 61 and is formed at an inner portion of the inner rotor 53a of the high-pressure oil pump 53.

That is, the boss portion 71 has a cylindrical shape, is integrally formed with the inner portion of the inner rotor 53a of the high-pressure oil pump 53, and operably connects the drive shaft 57 with the torque delivery shaft 61 together with the inner rotor 53a.

At this time, the drive shaft 57 and the torque delivery shaft 61 are splined or are coupled through a key or a polygonal shape respectively to the inner rotor 53a of the high-pressure oil pump 53 and the boss portion 71 for power delivery.

As shown in FIG. 3, it is exemplified in the exemplary embodiment of the present invention but is not limited that the inner rotor 53a of the high-pressure oil pump 53 and an interior circumference of the boss portion 71 are formed to have the polygonal shape, and exterior circumferences of the drive shaft 57 and the torque delivery shaft 61 are formed to have a shape corresponding to the polygonal shape such that the drive shaft 57 and the torque delivery shaft 61 are coupled respectively to the inner rotor 53a of the high-pressure oil pump 53 and the boss portion 71.

In addition, an exterior circumference of the boss portion 71 is rotatably supported by the connecting hole H so as to rotatably support the drive shaft 57 and the torque delivery shaft 61.

In addition, an end portion of an exterior circumference of the torque delivery shaft 61 is rotatably supported by the connecting hole H through a bushing 67.

It is exemplified in the exemplary embodiment of the present invention but is not limited that the end portion of the exterior circumference of the torque delivery shaft 61 is rotatably supported by the connecting hole H through the bushing 67. A bearing instead of the bushing 67 may be used.

In the oil pump for an automatic transmission 50 according to the exemplary embodiment of the present invention, the inner rotors 51a and 53a of the low-pressure oil pump 51 and the high-pressure oil pump 53 are connected by one torque delivery shaft 61 and are driven by one electric motor M.

In addition, if rotation speed of the electric motor M is controlled, hydraulic pressure and oil amount supplied to the low pressure portion and the high pressure portion can be optimized.

In addition, since the low-pressure oil pump 51 and the high-pressure oil pump 53 driven by one electric motor M are disposed in one housing 55, and the inner rotor 53a of the high-pressure oil pump 53 and the boss portion 71 are integrally formed with each other in the exemplary embodiment of the present invention, the torque delivery shaft 61 connected to the inner rotor 51a of the low-pressure oil pump 51 through the boss portion 71 and the inner rotor 53a of the high-pressure oil pump 53 are operably connected. Therefore, additional components for supporting shafts are not necessary.

Since the number of components can be reduced, a length, weight and cost of the oil pump may be minimized.

In addition, since the inner rotors 51a and 53a are centered directly in the housing 55 in a case that the low-pressure oil pump 51 and the high-pressure oil pump 53 are gear pumps, eccentricity between the inner rotors 51a and 53a and the outer rotors 51b and 53b and shaft misalignment due to gear flank play may be prevented.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. An oil pump apparatus for an automatic transmission comprising:
a housing provided with at least one hydraulic line formed therein;
a power source assembled to the housing and configured to apply torque through a drive shaft; and
two pumps disposed respectively at both end portions of the housing concentrically with the drive shaft, operably connected to each other through a torque delivery shaft, and pumping oil by receiving the torque from the drive shaft,
wherein an inner rotor of one oil pump of the two pumps is operably connected to the drive shaft, integrally formed with a boss portion, and operably connected to the torque delivery shaft operably connected to an inner rotor of another pump of the two pumps through the boss portion.

2. The oil pump apparatus of claim 1, wherein the two pumps comprise:
a low-pressure oil pump being the another oil pump, receiving the oil in an oil tank through the at least one hydraulic line, generating low pressure using the oil, and discharging generated low pressure; and
a high-pressure oil pump being the one oil pump, receiving a portion of the low pressure discharged from the low-pressure oil pump, generating high pressure using a portion of the low pressure, and discharging generated high pressure.

3. The oil pump apparatus of claim 2, wherein the at least one hydraulic line comprises:
an input line configured to supply the oil in the oil tank to the low-pressure oil pump;
a low-pressure discharge line configured to supply the oil discharged from the low-pressure oil pump to a low pressure portion;
a bifurcating line bifurcated from the low-pressure discharge line to supply a portion of the oil in the low-pressure discharge line to the high-pressure oil pump; and
a high-pressure discharge line configured to supply the oil discharged from the high-pressure oil pump to a high pressure portion.

4. The oil pump apparatus of claim 1, wherein the power source is an electric motor.

5. The oil pump apparatus of claim 1, wherein each of the two pumps is a vane pump.

6. The oil pump apparatus of claim 1, wherein each of the two pumps is a gear pump.

7. The oil pump apparatus of claim 1, wherein the boss portion has a cylindrical shape, is integrally formed with an inner portion of the inner rotor of the one oil pump, and operably connects the drive shaft with the torque delivery shaft together with the inner rotor of the one oil pump.

8. The oil pump apparatus of claim 1, wherein the drive shaft and the torque delivery shaft are splined or are coupled through a key or a polygonal shape respectively to the inner rotor of the one oil pump and the boss portion for power delivery.

9. The oil pump apparatus of claim 1, wherein an exterior circumference of the boss portion is rotatably supported by a connecting hole formed in the housing.

10. An oil pump apparatus for an automatic transmission comprising:
a housing provided with at least one hydraulic line formed therein;
an electric motor assembled to the housing and configured to apply torque through a drive shaft;
a low-pressure oil pump disposed at an end portion in the housing concentrically with the drive shaft, and generating and discharging low pressure by receiving oil in an oil tank through the at least one hydraulic line;
a high-pressure oil pump disposed at another end portion in the housing concentrically with the drive shaft, including an inner rotor connected to the drive shaft, and generating and discharging high pressure by receiving a portion of oil discharged from the low-pressure oil pump;
a torque delivery shaft in a connecting hole formed in the housing and provided with both end portions operably connected respectively to an inner rotor of the low-pressure oil pump and the inner rotor of the high-pressure oil pump; and
a boss portion into which another end portion of the torque delivery shaft is operably inserted and integrally formed with an inner portion of the inner rotor of the high-pressure oil pump.

11. The oil pump apparatus of claim 10, wherein the at least one hydraulic line comprises:
an input line configured to supply the oil in the oil tank to the low-pressure oil pump;
a low-pressure discharge line configured to supply the oil discharged from the low-pressure oil pump to a low pressure portion;
a bifurcating line bifurcated from the low-pressure discharge line to supply a portion of the oil in the low-pressure discharge line to the high-pressure oil pump; and
a high-pressure discharge line configured to supply the oil discharged from the high-pressure oil pump to a high pressure portion.

12. The oil pump apparatus of claim 10, wherein each of the low-pressure oil pump and the high-pressure oil pump is a vane pump.

13. The oil pump apparatus of claim 10, wherein each of the low-pressure oil pump and the high-pressure oil pump is a gear pump.

14. The oil pump apparatus of claim 10, wherein the boss portion has a cylindrical shape, is integrally formed with an inner portion of the inner rotor of the high-pressure oil pump, and operably connects the drive shaft with the torque delivery shaft together with the inner rotor of the high-pressure oil pump.

15. The oil pump apparatus of claim 10, wherein the drive shaft and the torque delivery shaft are splined or are coupled through a key or a polygonal shape respectively to the inner rotor of the high-pressure oil pump and the boss portion for power delivery.

16. The oil pump apparatus of claim 10, wherein an exterior circumference of the boss portion is rotatably supported by the connecting hole.

17. The oil pump apparatus of claim 10, wherein an exterior circumference of an end portion of the torque delivery shaft is rotatably supported by the connecting hole through a bearing.

18. The oil pump apparatus of claim 10, wherein an exterior circumference of an end portion of the torque delivery shaft is rotatably supported by the connecting hole through a bushing.
